(19) United States
(12) Patent Application Publication
(10) Pub. No.: US 2009/0063609 A1
(43) Pub. Date: Mar. 5, 2009

(54) Static 4:2 Compressor with Fast Sum and Carryout

(76) Inventor: Honkai Tam, Redwood City, CA (US)

Correspondence Address: MHKKG, PC/Apple, Inc., P.O. Box 398, Austin, TX, 78767-0398, US

(21) Appl. No.: 11/760,547

(22) Filed: Jun. 8, 2007

(51) Int. Cl. G06F 7/50

(52) U.S. Cl. 708/708

(57) ABSTRACT

In one embodiment, a compressor circuit has a carry-in input and input bits a, b, c, and d. The compressor circuit comprises a first multiplexor (mux) coupled to receive a value of input bit a and a complement of the value of input bit a as inputs and a value of the input bit b as a first selection control. The first mux has a first output. Coupled to receive a value of input bit c and a complement of the value of input bit c as inputs and a value of the input bit d as a second selection control, a second mux has a second output. A third mux is coupled to receive the first output and a complement of the first output as inputs and the second output as a third selection control, and the third mux has a third output. The fourth mux, coupled to receive a value of the third output and a complement of a value of the third output as inputs and the carry-in input as a fourth selection control, has a fourth output which is a sum output of the compressor circuit. In another embodiment, a processor comprises an arithmetic unit comprising a plurality of the compressor circuits arranged in two or more levels of compressor circuits. By making use of the redundancy available in the compressor outputs, the carry logic may be more efficient than previous designs. Additionally, a fast sum generation (e.g. 3 two input XOR delays) may be implemented.

### BACKGROUND

1. Field of the Invention

This invention is related to the field of processors and, more particularly, to compressor circuitry used in arithmetic processing in processors.

2. Description of the Related Art

Processors are designed to execute instructions that can be categorized into several broad types: arithmetic, logic, control flow (or branch), load/store, etc. Arithmetic instructions may include instructions for various types of arithmetic. For example, floating point and integer arithmetic is common in modern processors. Some processors also implement single instruction, multiple data (SIMD) processing in which multiple independent arithmetic operations are performed on independent portions of the input operands. SIMD operations are sometimes referred to as vector operations as well.

Arithmetic operations of various types often are implemented using 4:2 compressor circuits for at least a portion of the operation. The 4:2 compressor circuits are also sometimes referred to as carry save adder (CSA) circuits. This description will use the term compressor circuits. An example of an arithmetic operation that can be implemented using 4:2 compressor circuits is multiplication. Multiplication can be implemented as booth recoded partial product addition, which can be performed using multiple levels of 4:2 compressors. Each level includes a plurality of compressors. The compressor at a given level receive various input bits from the next higher level and a carry-in from another compressor at the same level. Each compressor at a given level provides a carry out to another compressor at the same level, and sum and carry outputs to the next lower level. Over the levels, the sum and carry outputs are added until a result is generated. Typically, a 4:2 compressor is implemented as two full adders (3:2 compressors) in series.

### SUMMARY

In one embodiment, a compressor circuit has a carry-in input and input bits a, b, c, and d. The compressor circuit comprises a first multiplexor (mux) coupled to receive a value of input bit a and a complement of the value of input bit a as inputs and a value of the input bit b as a first selection control. The first mux has a first output. Coupled to receive a value of input bit c and a complement of the value of input bit c as inputs and a value of the input bit d as a second selection control, a second mux has a second output. A third mux is coupled to receive the first output and a complement of the first output as inputs and the second output as a third selection control, and the third mux has a third output. The fourth mux, coupled to receive a value of the third output and a complement of a value of the third output as inputs and the carry-in input as a fourth selection control, has a fourth output which is a sum output of the compressor circuit. In another embodiment, a processor comprises an arithmetic unit comprising a plurality of the compressor circuits arranged in two or more levels of compressor circuits.

In an embodiment, an apparatus comprises a compressor circuit having a carry-in input and input bits a, b, c, and d. The compressor circuit comprises logic circuitry configured to generate a sum output, a first carry output, and a second carry output. The sum output is the exclusive OR of the input bits a, b, c, and d and the carry-in input. The first carry output is the exclusive OR of the input bits a, b, c, and d logically ANDed with the carry-in input, the result of which is logically ORed with the exclusive NOR of the input bits a, b, c, and d logically ANDed with the logical OR of the logical AND of input bits a and b and the logical AND of input bits c and d. The second carry output is the logical AND of the logical OR of input bits a and b and the logical OR of input bits c and d.

### BRIEF DESCRIPTION OF THE DRAWINGS

The following detailed description makes reference to the accompanying drawings, which are now briefly described.

FIG. 1 is a block diagram of one embodiment of a system.

FIG. 2 is a circuit diagram of one embodiment of a 4:2 compressor.

FIG. 3 is a circuit diagram of one embodiment of a 2:1 multiplexor (mux).

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

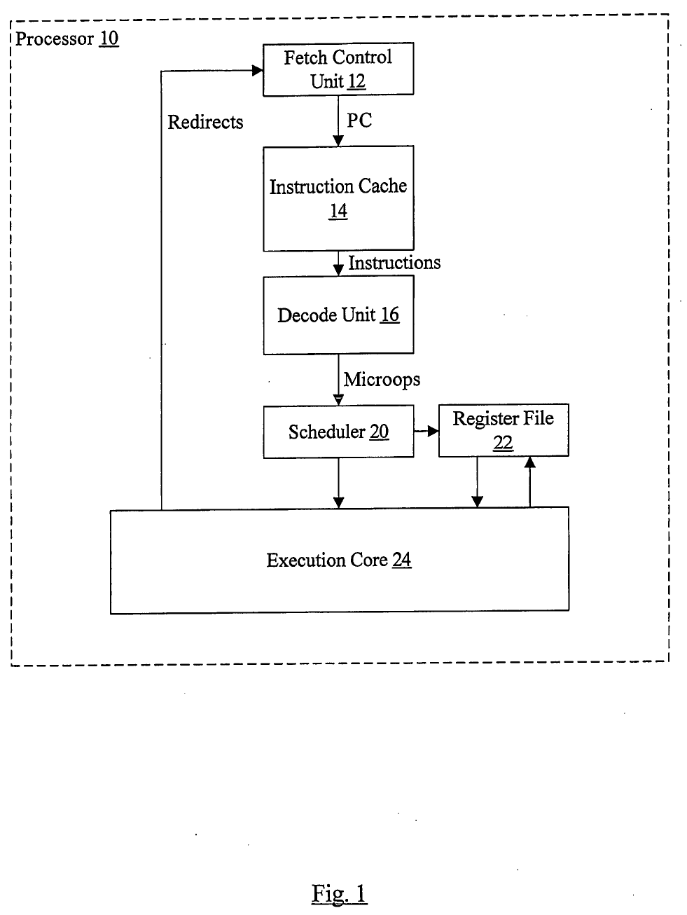

Turning now to FIG. 1, a block diagram of one embodiment of a processor 10 is shown. In the illustrated embodiment, the processor 10 includes a fetch control unit 12, an instruction cache 14, a decode unit 16, a scheduler 20, a register file 22, and an execution core 24. The execution core 24 comprises an arithmetic unit 26 that includes a plurality of 4:2 compressor circuits 28A-28N. The fetch control unit 12 is coupled to provide a program counter (PC) for fetching from the instruction cache 14, and is coupled to receive a redirect from the execution core 24. The instruction cache 14 is coupled to provide instructions to the decode unit 16, which is coupled to provide microops to the scheduler 20. The scheduler 20 is coupled is coupled to the register file 22, and is coupled to provide microops for execution to the execution core 24. The register file 22 is coupled to provide operands to the execution core 24 and to receive results from the execution core 24. It is noted that the PC of an instruction may be an address that locates the instruction itself in memory. That is, the PC is the address that may be used to fetch the instruction. The PC may be an effective or virtual address that is translated to the physical address actually used to access the memory, or may be a physical address, in various embodiments.

The decode unit 16 may be configured to generate microops for each instruction provided from the instruction cache 14. Generally, the microops may each be an operation that the hardware included in the execution core 24 is capable of executing. Each instruction may translate to one or more microops which, when executed, result in the performance of the operations defined for that instruction according to the instruction set architecture. The decode unit 16 may include any combination of circuitry and/or microcoding in order to generate microops for instructions. For example, relatively simple microop generations (e.g. one or two microops per instruction) may be handled in hardware while more extensive microop generations (e.g. more than three microops for an instruction) may be handled in microcode. The number of microops generated per instruction in hardware versus microcode may vary from embodiment to embodiment. Alternatively, each instruction may map to one microop executed by the processor. Accordingly, an operation may be an operation derived from an instruction or may be a decoded instruction, as desired.

Microops generated by the decode unit 16 may be provided to the scheduler 20, which may store the microops and may schedule the microops for execution in the execution core 24. In some embodiments, the scheduler 20 may also implement register renaming and may map registers specified in the microops to registers included in the register file 22. When a microop is scheduled, the scheduler 20 may read its source operands from the register file 22 and the source operands may be provided to the execution core 24.

Among the microops executed by the execution core may be various arithmetic operations that may use the 4:2 compressors 28A-28N in the arithmetic unit 26. For example, floating point or integer multiplication may use the compressors 28A-28N for partial product additions. The compressor circuits 28A-28N may be arranged into multiple levels (e.g. two levels are illustrated as horizontal rows in FIG. 1). Each level may receive input bits from a higher level (e.g. a booth recoder (not shown in FIG. 1) for the highest level, or a previous level of 4:2 compressors, for other levels). Each compressor circuit 28A-28N may also receive a carry-in input from another compressor circuit at the same level and may provide a carry-out output to another compressor circuit 28A-28N at the same level. Each compressor circuit 28A-28N may also generate a sum and a carry output for the next lower level. The lowest level of compressor circuits 28A-28N may be coupled to other logic that generates the final result. The execution core 24 may include other circuitry to perform other integer operations, floating point operations, load/store operations, branch operations, etc.

The register file 22 may generally comprise any set of registers usable to store operands and results of microops executed in the processor 10. In some embodiments, the register file 22 may comprise a set of physical registers and the scheduler 20 may map the logical registers to the physical registers. The logical registers may include both architected registers specified by the instruction set architecture implemented by the processor 10 and temporary registers that may be used as destinations of microops for temporary results (and sources of subsequent microops as well). In other embodiments, the register file 22 may comprise an architected register set containing the committed state of the logical registers and a speculative register set containing speculative register state.

The fetch control unit 12 may comprise any circuitry used to generate PCs for fetching instructions. The fetch control unit 12 may include, for example, branch prediction hardware used to predict branch instructions and to fetch down the predicted path. The fetch control unit 12 may also be redirected (e.g. via misprediction, exception, interrupt, flush, etc.).

The instruction cache 14 may be a cache memory for storing instructions to be executed by the processor 10. The instruction cache 14 may have any capacity and construction (e.g. direct mapped, set associative, fully associative, etc.). The instruction cache 14 may have any cache line size. For example, 64 byte cache lines may be implemented in one embodiment. Other embodiments may use larger or smaller cache line sizes. In response to a given PC from the fetch control unit 12, the instruction cache 14 may output up to a maximum number of instructions. For example, up to 4 instructions may be output in one embodiment. Other embodiments may use more or fewer instructions as a maximum.

It is noted that, while the illustrated embodiment uses a scheduler, other embodiments may implement other microarchitectures. For example, a reservation station/reorder buffer microarchitecture may be used. If in-order execution is implemented, other microarchitectures without out of order execution hardware may be used.

In one embodiment, the 4:2 compressors 28A-28N do not implement the series connection of 3:2 compressors previously used in to implement a 4:2 compressor. Additionally, the carry terms used to generate the carry output of the 4:2 compressors 28A-28N that is provided to the next level, and the terms used to generate the carry out to another compressor at the same level are changed. In one embodiment, the generation of the carry outputs may be more efficient than was previously possible. Additionally, in one embodiment, a low latency implementation using 2:1 multiplexors (muxes) and inverters may be used so that the delay through the 4:2 compressor is relatively low. Viewed in another way, the two carry outputs and the sum output have redundancy (up to 8 possible variations on the three outputs, but only five possible sums with 4 inputs and a carry-in input). By redesigning the encoding of the outputs, a high efficiency implementation may be realized.

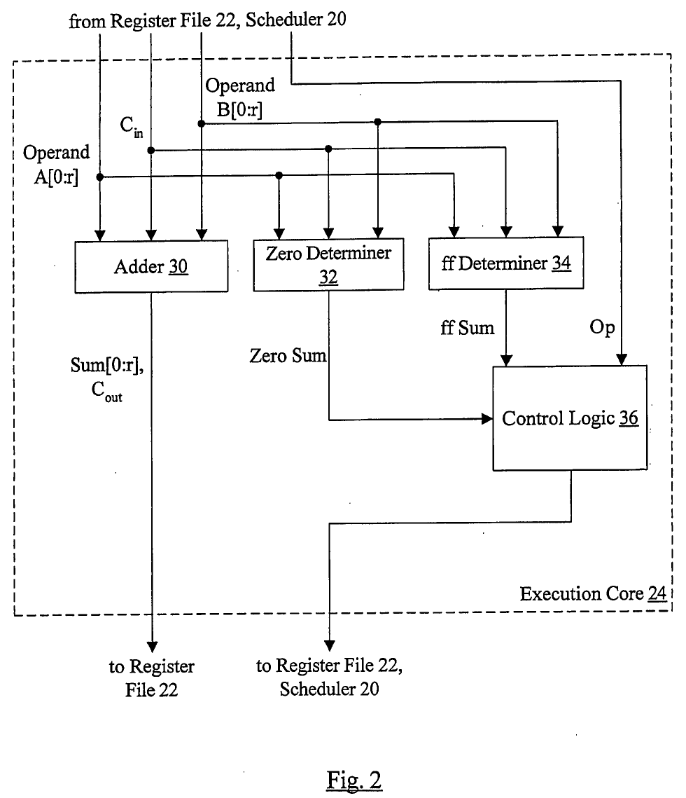

In one embodiment, the following equations are implemented by the 4:2 compressor circuits 28A-28N. In the equations, as well as in FIG. 2, the four input bits from the next higher level are labeled a, b, c, and d; the carry-in input from the same level is labeled Cin; the sum and carry outputs to the next lower level are labeled Sum and Carry; and the carry-out output to the next compressor in the same level is labeled Cout. A carat (̂) indicates exclusive OR (XOR), an ampersand (&) indicates AND, a vertical bar (|) indicates OR, and a tilde (~) indicates logical NOT (or complement, or inversion).

Sum=((âb)̂(ĉd))̂Cin (1)

Carry=((âb̂ĉd)&Cin)|(~(âb̂ĉd)&((a&b)|(c&d))) (2)

Cout=(a|b)&(c|d) (3)

Equation 1 may be implemented with 4 two input XOR operations, with only three in series, as indicated by the parentheses in equation 1. Other embodiments may implement the XOR operation in any desired fashion. That is, two XORs may be performed in parallel (âb and ĉd), the results XORed ((âb)̂(ĉd)), and the result of the second XOR level may be XORed with Cin. Additionally, the output of the second level may be used for the Carry equation (equation 2). Accordingly, in some embodiments, the circuitry to implement the compressor circuit may be small.

A number of two input XOR operations are used, in one embodiment. A two input XOR operation may be implemented as a 2:1 mux, where the inputs to the mux are one of the XOR input bits and its inverse (or complement), and the mux select is the other input bit. For example, if x XOR y is to be implemented, the inputs to the mux may be “x” and “˜x” and the control input may be “y”. If y is one, ˜x may be selected; and if y is zero, x may be selected. In one embodiment, a passgate mux implementation may be used to further speed the 2 input XOR operation.

One embodiment of the 4:2 compressor circuit 28A is shown in FIG. 2. Other compressor circuits 28B-28N may be similar. As mentioned above, the input bits to the compressor circuit are a, b, c, and d. The carry-in input bit is Cin, and the carry-out output bit to the compressor circuit at the same level is Cout. The sum and carry outputs to the next lower level are Sum and Carry.

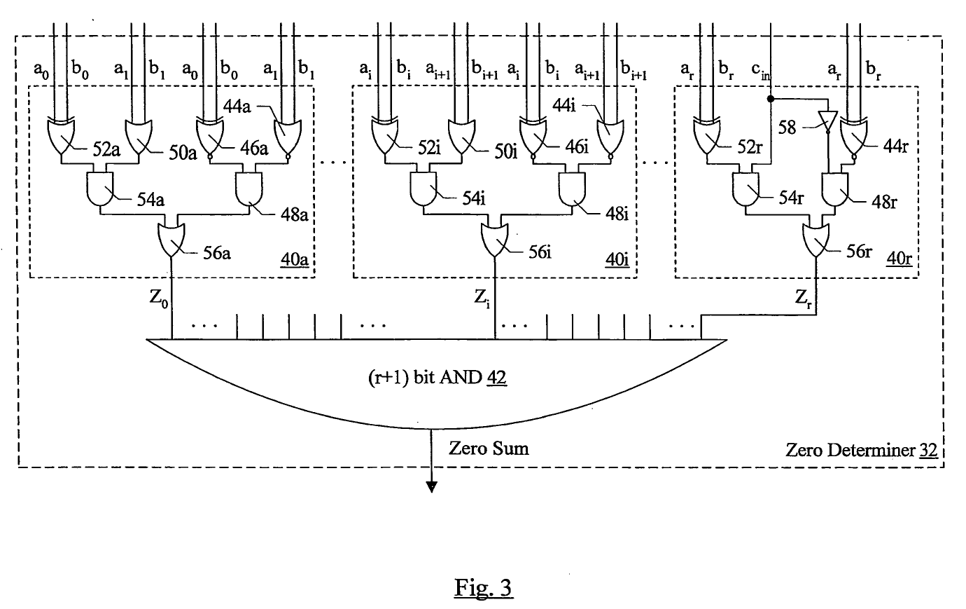

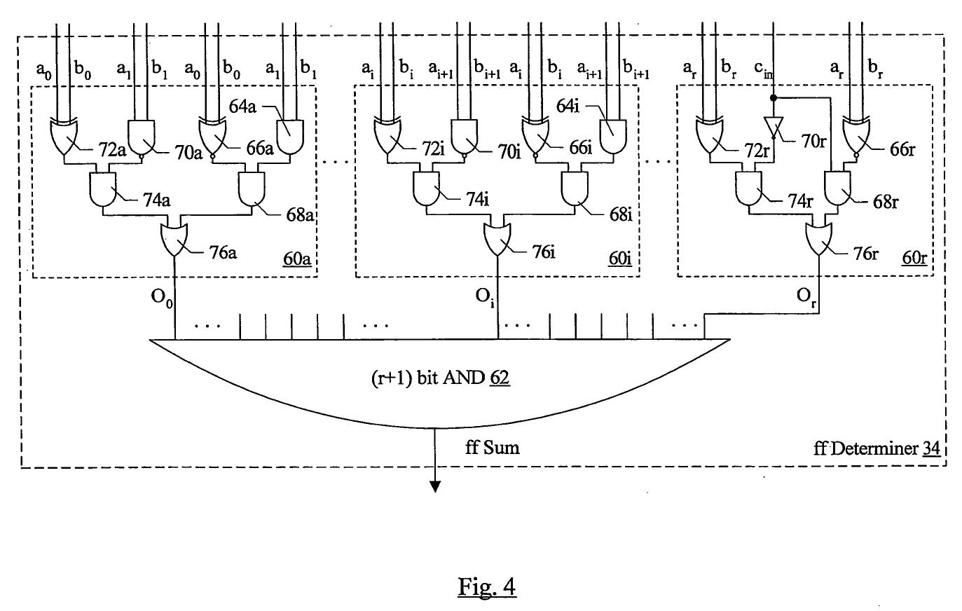

The embodiment illustrated in FIG. 2 uses 2:1 muxes to implement XOR functions (and XNOR functions, since the inverse of an XOR may be used at some points). The 2:1 muxes have two inputs, labeled “0” and “1”. There are two select inputs shown. The upper select input may be the “true” select, and the lower select may be its complement. The “0” input may be selected if the true select is zero (and thus its complement is 1). The “1” input may be selected if the true select is one (and thus its complement is 0). The true and complement selects may be logical complements of each other, although some amount of timing difference may be acceptable. The 2:1 muxes may be implemented as pass gate muxes (e.g. as shown in FIG. 3). In other embodiments, the complement mux select may be generated within the muxes themselves, if desired. In still other embodiments, non-passgate muxes may be used.

The mux 30A is coupled to receive the value of input bit a on its 0 input (through the inverters 32 and 34, in this embodiment) and the complement of the value of input bit a on its 1 input (through inverter 32 only, in this embodiment. The true select is b, and the complement select is ˜b. Accordingly, if b is logical 1, then the complement of a is output by the mux 30A and if b is logical zero, a is output. Thus, mux 30A implements a ̂b. The mux 30B receives the inputs in the reverse order from mux 30A, but the same mux select. That is, the mux 30B is coupled to receive the complement of a on its 0 input and a on its 1 input. Accordingly, the mux 30B outputs the complement of a if b is 0, and a if b is 1. Thus, mux 30B performs an XNOR operation (~(âb)). Similarly, the muxes 30C-30D are coupled to receive the c input and its complement (via inverters 36 and 38) and perform XOR and XNOR operations, respectively, based on the d input.

The second level of two input XORing may be implemented by the muxes 30E and 30F in FIG. 2. The mux 30E receives a ̂b on its 0 input and ~(âb) on its 1 input. The true select is ~(ĉd) and the complement select is (ĉb). Thus, the mux 30E provides âb̂ĉd on its output. The mux 30F has the reverse order of inputs and same mux selects as the mux 30E, and thus provides ~(âb̂ĉd) on its output. Each output is inverted (inverters 40 and 42) and thus the output of inverter 40 is ~(âb̂ĉd) and the output of inverter 42 is âb̂ĉd. The mux 30G thus receives âb̂ĉd on its 0 input and ~(âb̂ĉd) on its 1 input. The mux 30G is controlled by Cin and its complement, and thus outputs âb̂ĉd̂Cin, which is the Sum output.

A mux 44 is also shown in FIG. 2, which may be a 2:1 mux similar to the muxes 30A-30G. The true mux select is the output of the inverter 40 (~(âb̂ĉd)) and the complement mux select is the output of the inverter 42 (âb̂ĉd). Accordingly, if âb̂ĉd is a one, the true mux select is a zero and Cin is selected as the output of mux 44 (the first portion of equation 2). If âb̂ĉd is a zero, the true mux select is a 1 and the input 1 of the mux 44 is select. Input 1 of the mux 44 is the output of an OR gate 46, which has the outputs of AND gates 48 and 50 as inputs. The AND gate 48 has c and d as inputs, and the AND gate 50 has a and b as inputs. Thus, the AND gates 48 and 50 and the OR gate 46 implement (a & b)|(c & d). When selected as the output of the mux 44 (when the true mux input to mux 44 is a 1), the second portion of equation 2 is implemented. Accordingly, the output of the mux 44 is the Carry output of the 4:2 compressor 28A.

Finally, the OR gate 52 (having c and d as inputs), the OR gate 54 (having a and b as inputs), and the AND gate 56 (having the outputs of OR gates 52 and 54 as inputs) generate the Cout output as set forth in equation 3.

It is noted that, while specific logic circuits are shown in FIG. 2, other embodiments may implement any desired logic that implements the equations (1), (2), and (3) above, including any Boolean equivalents of the circuitry shown.

It is noted that, since the output of the mux 30B is the complement of the mux 30A, other embodiments may eliminate the mux 30B in favor of inverting the output of the mux 30A (or vice versa). Such an implementation may be slower than the implementation shown in FIG. 2, but is another possible embodiment. Similarly, the mux 30D may be eliminated in favor of inverting the output of mux 30C (or vice versa); and the mux 30F may be eliminated in favor of the non-inverted output of the mux 30E (or vice versa). It is further noted that inverters 40 and 42 may be eliminated by swapping the connections of the outputs of the muxes 30E-30F to the inputs of the mux 30G and the selection controls of the mux 44.

In one embodiment, the muxes 30A-30G and 44 may be implemented as pass gate muxes. One such embodiment of the mux 30A is shown in FIG. 3. Other muxes may be similar (except that the mux select inputs may be changed).

It is noted that various circuitry above has been described as receiving a value of an bit or signal, or perhaps just receiving a bit or signal. Generally, the value of the bit or signal may be received. The actual bit or signal may be received directly, or one or more levels of buffering or inversion may separate the bit or signal and the receiver. However, the logical state of the bit or signal is received as described, whether directly or indirectly through buffering.

Numerous variations and modifications will become apparent to those skilled in the art once the above disclosure is fully appreciated. It is intended that the following claims be interpreted to embrace all such variations and modifications.

What is claimed is:

1. A compressor circuit having a carry-in input and input bits a, b, c, and d, the compressor circuit comprising:
a first multiplexor (mux) coupled to receive a value of input bit a and a complement of the value of input bit a as inputs and a value of the input bit b as a first selection control, and the first mux having a first output;
a second mux coupled to receive a value of input bit c and a complement of the value of input bit c as inputs and a value of the input bit d as a second selection control, and the second mux having a second output;
a third mux coupled to receive a value of the first output and a complement of the value of the first output as inputs and the second output as a third selection control, and the third mux having a third output; and
a fourth mux coupled to receive a value of the third output and a complement of a value of the third output as inputs and the carry-in input as a fourth selection control, and the fourth mux having a fourth output which is a sum output of the compressor circuit.

2. The compressor circuit as recited in claim 1 wherein each of the first mux, the second mux, the third mux, and the fourth mux is a passgate mux.

3. The compressor circuit as recited in claim 1 further comprising:
a fifth mux coupled to receive the value of the input bit a and the complement of the value of the input bit a in a reverse order as received by the first mux, wherein the fifth mux is coupled to receive the value of the input bit b as a fifth selection control, and the fifth mux having a fifth output;
a sixth mux coupled to receive the value of the input bit c and the complement of the value of the input bit c in a reverse order as received by the second mux, wherein the sixth mux is coupled to receive the value of the input bit d as a sixth selection control, and the sixth mux having a sixth output; and
a seventh mux coupled to receive the value of the first output and a complement of the value of the first output as inputs and the second output as a seventh selection control, and the seventh mux having a seventh output.

4. The compressor circuit as recited in claim 3 wherein the fifth output is the complement of the first output that is received by the third mux, and wherein the sixth output is the complement of the second output that is a complement selection control to the third mux and the seventh mux, and wherein the seventh output is a complement of the third output.

5. The compressor circuit as recited in claim 4 further comprising a first inverter and a second inverter, wherein the first inverter has the third output as an input, wherein the value of the complement of the third output is an output of the first inverter, and wherein the second inverter has the seventh output as an input, and wherein the value of the third output is the output of the second inverter.

6. The compressor circuit as recited in claim 1 further comprising an eighth mux having the carry-in input as an input and the another input generated from the values of the input bits a, b, c, and d, and wherein an the eighth mux has the value of the third output as an eighth selection control, wherein the eighth mux has an eighth output that is carry output of the compressor circuit.

7. The compressor circuit as recited in claim 6 wherein the another input of the eighth mux is generated as the logical OR of: 1) the logical AND of the values of input bits a and b; and 2) the logical AND of the values of the input bits c and d.

8. The compressor circuit as recited in claim 6 further comprising a logic circuit configured to generate a second carry output of the compressor circuit, the second carry output generated as the logical AND of: 1) the logical OR of the values of input bits a and b; and the logical OR of the values input bits c and d.

9. A processor comprising an arithmetic unit comprising a plurality of compressor circuits arranged in two or more levels of compressor circuits, wherein each compressor circuit is coupled to receive input bits a, b, c, and d from a higher level circuit and a carry-in input from another compressor circuit in the same level, and wherein each of the plurality of compressor circuits comprises:
a first multiplexor (mux) coupled to receive a value of input bit a and a complement of the value of input bit a as inputs and a value of the input bit b as a first selection control, and the first mux having a first output;
a second mux coupled to receive a value of input bit c and a complement of the value of input bit c as inputs and a value of the input bit d as a second selection control, and the second mux having a second output;
a third mux coupled to receive a value of the first output and a complement of the value of the first output as inputs and the second output as a third selection control, and the third mux having a third output; and
a fourth mux coupled to receive a value of the third output and a complement of a value of the third output as inputs and the carry-in input as a fourth selection control, and the fourth mux having a fourth output which is a sum output of the compressor circuit provided to a next lower level of the compressor circuits.

10. The processor as recited in claim 9 wherein each of the first mux, the second mux, the third mux, and the fourth mux is a passgate mux.

11. The processor as recited in claim 9 wherein each of the plurality of compressor circuits further comprises:
a fifth mux coupled to receive the value of the input bit a and the complement of the value of the input bit a in a reverse order as received by the first mux, wherein the fifth mux is coupled to receive the value of the input bit b as a fifth selection control, and the fifth mux having a fifth output;
a sixth mux coupled to receive the value of the input bit c and the complement of the value of the input bit c in a reverse order as received by the second mux, wherein the sixth mux is coupled to receive the value of the input bit d as a sixth selection control, and the sixth mux having a sixth output; and
a seventh mux coupled to receive the value of the first output and a complement of the value of the first output as inputs and the second output as a seventh selection control, and the seventh mux having a seventh output.

12. The processor as recited in claim 11 wherein the fifth output is the complement of the first output that is received by the third mux, and wherein the sixth output is the complement of the second output that is a complement selection control to the third mux and the seventh mux, and wherein the seventh output is a complement of the third output.

13. The processor as recited in claim 12 wherein each of the plurality of compressor circuits further comprises a first inverter and a second inverter, wherein the first inverter has the third output as an input, wherein the value of the complement of the third output is an output of the first inverter, and wherein the second inverter has the seventh output as an input, and wherein the value of the third output is the output of the second inverter.

14. The processor as recited in claim 9 further comprising an eighth mux having the carry-in input as an input and the another input generated from the values of the input bits a, b, c, and d, and wherein an the eighth mux has the value of the third output as an eighth selection control, wherein the eighth mux has an eighth output that is carry output to a next lower level of the compressor circuits.

15. The processor as recited in claim 14 wherein the another input of the eighth mux is generated as the logical OR of: 1) the logical AND of the values of input bits a and b; and 2) the logical AND of the values of the input bits c and d.

16. The processor as recited in claim 14 wherein each of the plurality of compressor circuits further comprises a logic circuit configured to generate a second carry output to another compressor circuit in the same level, the second carry output generated as the logical AND of: 1) the logical OR of the values of input bits a and b; and the logical OR of the values input bits c and d.

17. An apparatus comprising a compressor circuit having a carry-in input and input bits a, b, c, and d, the compressor circuit comprising logic circuitry configured to generate a sum output, a first carry output, and a second carry output, wherein the sum output is the exclusive OR of the input bits a, b, c, and d and the carry-in input; and wherein the first carry output is either the exclusive OR of the input bits a, b, c, and d logically ANDed with the carry-in input or the exclusive NOR of the input bits a, b, c, and d logically ANDed with the logical OR of the logical AND of input bits a and b and the logical AND of input bits c and d; and wherein the second carry output is the logical AND of the logical OR of input bits a and b and the logical OR of input bits c and d.

18. The apparatus as recited in claim 17 wherein the circuitry that generates the sum output comprises a plurality of 2:1 muxes implementing the exclusive OR operation.

19. The apparatus as recited in claim 18 wherein the plurality of 2:1 muxes are passgate muxes.
